(19) United States
(12) Patent Application Publication
(10) Pub. No.: US 2003/0101185 A1
(43) Pub. Date: May 29, 2003

(54) Method for synchronously updating screen data of database application program at clients over network

(75) Inventor: Ming-Hsiao Hsieh, Taipei (TW)

Correspondence Address: BACON & THOMAS, PLLC, 625 SLATERS LANE, FOURTH FLOOR, ALEXANDRIA, VA, 22314

(73) Assignee: INVENTEC CORPORATION, Taipei (TW)

(21) Appl. No.: 09/993,481

(22) Filed: Nov. 27, 2001

(51) Int. Cl. G06F 7/00

(52) U.S. Cl. 707/10

(57) ABSTRACT

A method for synchronously updating screen data of database application program at clients over network utilizes a reference table installed in a server of a network system to record filenames of databases in the server opened by the clients over the network, therefore when one client updates data of the database, the client will read the reference table for identifying the filenames of the databases opened by other clients, transmitting the updated data to the other clients and synchronously updating data of corresponding fields on a screen of the database application program at the other clients.

### FIELD OF THE INVENTION

The present invention relates to data communication network and more particularly to a method for synchronously updating screen data of database application program at clients over network.

### BACKGROUND OF THE INVENTION

In recent years, as the rapid development of the Internet and lower cost of establishing network (including hardware and software) more and more enterprises are capable of installing intranet for connecting with related manufacturers. Such intranet is further coupled to applications of database system for collecting information and processing, calculating, and analyzing the same so as to procure the latest information. Particularly for multi-national enterprises, it is required to integrate their processes of product design, development, manufacturing and marketing the whole world for tailoring the needs of various domestic and international markets, and quickly design and manufacture commercially available products and distribute them throughout the world. In order to archive this requirement, those multi-national enterprises have utilized the local area network (LAN) to increase the efficiency of information communication within the organization, and further utilized the Internet to communicate with cooperating manufacturers and retrieve latest market information in a fast and correct manner. As a result, such products being manufactured are not only what consumers want, but also very competitive in price. This in turn can increase sales, and thus greatly reduces the inventory cost.

In general, a network system established within an enterprise comprises a server, a plurality of clients and a large database system provided in the server. Such database system comprises a plurality of databases for storing a variety of records each having a plurality of distinct fields based on its characteristic. For example, a typical order in a manufacturer's database comprises fields of serial number, type, part number, unit price, etc. Such fields consist of a record of database. Each of the plurality of clients is coupled to server. Further, a screen of database application program is available for user to enter a database system at server via one of the clients. Thus, user can input data into a record of database or search stored data in records of database. In the above network system, the data being updated in database system at the server by a client cannot be transmitted to all other clients synchronously. Hence, it is impossible to synchronously update the screen data of database application program at other clients. For overcoming such problem, many enterprises design a mechanism in a network based database system for clients to regularly read updated data from server so as to display latest data on screen of database application program at each client. As a result, user can see latest data from screen of database application program at every client in any time. This technique can generally solve above problem. However, it significantly increases the times of clients reading updated data by entering server. As a result, the load of server is very heavy.

Thus, it is desirable to provide a method for synchronously updating screen data of database application program at clients over network in order to overcome the above problem of prior art.

### SUMMARY OF THE INVENTION

It is therefore an object of the present invention to provide a method for synchronously updating screen data of database application program at clients over network. When any client updates data of database system at server, the updated data will be synchronously transmitted to other clients by referring to a reference table. As an end, data of related fields on screen of database application program at other clients are synchronously updated. This eliminates the problem of prior art which requires each client to regularly read updated data from server for displaying latest data on screen of database application program at each client. As a result, the invention can effectively decrease the times of clients reading updated data by entering server, thereby significantly reducing the load of server.

To achieve the above object, the present invention provides a method comprising installing a reference table at a server of a network system; recording filenames of databases in a database system opened by the clients over the network system in the reference table; when one of the clients updates data of the database at the server, enabling the client to read the reference table for identifying the filenames of the databases opened by the other clients; and transmitting updated data at one client to the other clients; and updating data of corresponding fields on a screen of the database application program at the other clients. By utilizing this method, the purpose of synchronously updating screen data of a database application program at clients is achieved.

The above and other objects, features and advantages of the present invention will become apparent from the following detailed description taken with the accompanying drawings.

### BRIEF DESCRIPTION OF THE DRAWINGS

FIG. 1 schematically depicts connections of a server and a plurality of clients in a network system according to the invention;

FIG. 2 is a table showing fields of reference table according to the invention;

FIG. 3 is a flow chart illustrating a process at server of FIG. 1 network system; and

FIG. 4 is a flow chart illustrating a process at one of clients of FIG. 1 network system.

### DETAILED DESCRIPTION OF THE PREFERRED EMBODIMENTS

In a current network system, computer at each of client and computer at server are capable of communicating data by utilizing a network communication protocol implemented on an installed network application program. In an example of utilizing a communication protocol (e.g., Transport Control Protocol/Internet Protocol, which is abbreviated to TCP/IP) for communicating data over network, computers at each of client and server in the network system have to designate a set of IP address and communication port number (e.g., PORT) by executing the installed network application program, in which the combination of IP address and PORT is so-called “socket”. Therefore, if any two computers are going to communicate data therebetween over network, the computers have to have a pair of matched sockets and set a TCP communication protocol by the network application program installed therein. Hence, prior to transmitting data over the network one computer has to establish a communication channel with other computers by utilizing the TCP communication protocol, and will close the communication channel after the data has been transmitted.

The present invention utilizes the characteristics of data communication among computers over the network system, and installs a reference table at a server of network system. Thus, filenames of all databases in a database system opened by a plurality of clients over the network are recorded in the reference table. When one of clients updates data of a certain database at server, the client can read the reference table for identifying the filenames of databases opened by other clients and subsequently transmitting updated data at the client to other clients so as to update data of corresponding fields on screen of database application program at other clients accordingly. As a result, the purpose of synchronously updating screen data of database application program at clients is achieved.

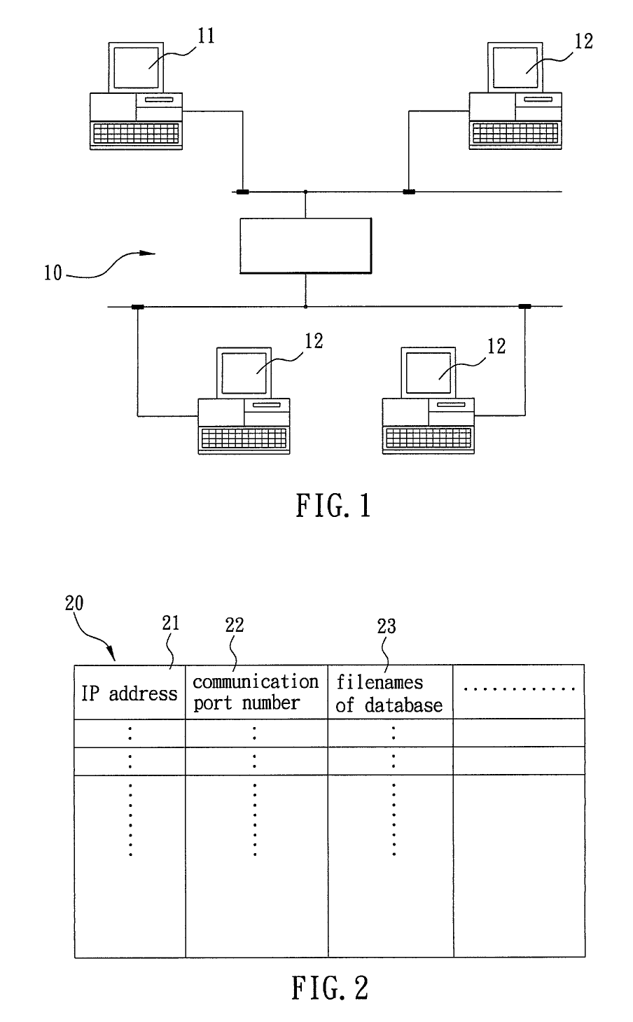

Referring to FIG. 1, in a preferred embodiment of the present invention, a network system 10 comprises at least one server 11 and a plurality of clients 12 coupled to the server 11. As shown, each client 12 and server 11 are capable of communicating data by utilizing a network communication protocol (e.g., TCP/IP communication protocol in this embodiment but may be a different one in any of other embodiments) implemented on an installed network application program on the network system 10. In this invention, a database system is further provided in the server 11. The database system comprises at least one database for storing a variety of records each having a unique filename of the database. A database application program capable of entering the database system is installed in the client 12. Hence, a screen of database application program at each client is available for user to enter the database system at the server and input data into a record of the database or search stored data in records of the database.

Referring to FIG. 1, there is shown a reference table 20 in the server. The reference table 20 comprises a plurality of fields (those labeled as 21, 22 and 23) for storing IP address, communication port number (e.g., PORT), and filename of database (opened by the database application program at each client for entering the database system at the server) of each client coupled to server. Thus, when any one of the clients enters the database system at server and updates data of a certain database thereof, the client can read the reference table 20 for identifying filenames of databases opened by other clients coupled to server and subsequently transmitting the updated data to other clients so as to update data of corresponding fields on screen of database application program at other clients. As a result, the purpose of synchronously updating screen data of database application program at clients is achieved.

In the preferred embodiment, each client can enter database system at server by executing the installed database application program as well as the database application program of database system downloaded from the server. Hence, user can input data into a record of database or search data stored in records of database through the screen of database application program at client.

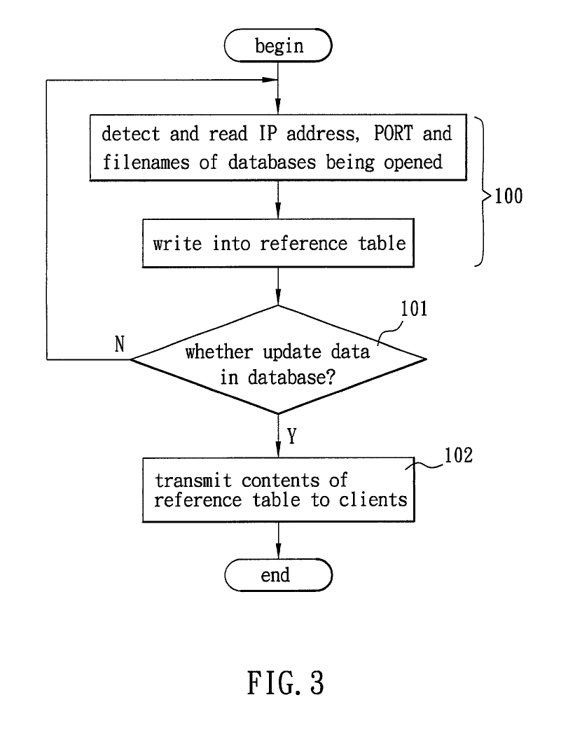

Referring to FIG. 3, there is illustrated a process at server of the network system. The process comprises the following steps:

In step 100, detect and read IP address, communication port number (e.g., PORT) and filenames of databases of the base system opened by each client. Then sequentially write the same into corresponding fields of the reference table;

In step 101, determine whether an updating is performed on the record of database corresponding to the filename of database being opened after each client has entered the server; if yes, the process goes to step 102, otherwise, the process loops back to step 100;

In step 102, transmit contents of the reference table to the clients after the updating.

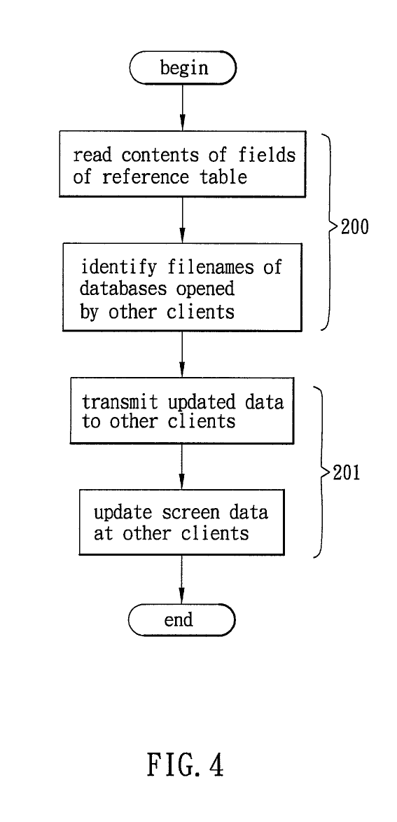

Referring to FIG. 4, there is illustrated a process at the client after the reference table transmitted from server has been received therein. The process comprises the following steps:

In step 200, read the contents of fields of the reference table for identifying filenames of databases opened by other clients;

In step 201, transmit the updated data to other clients for updating data of the related fields on screen of database application program at each of other clients. As a result, the purpose of synchronously updating screen data of database application program at clients is achieved.

As stated above, in the present invention when any client is updating data of the database system at server, the updated data will be synchronously transmitted to other clients by referring to the reference table. As an end, data of the related fields on screen of the database application program at other clients are synchronously updated. This eliminates the problem of prior art which requires each client to regularly read updated data from server for displaying latest data on screen of database application program at each client. As a result, the invention can effectively decrease the times of client reading updated data by entering server, thereby significantly reducing the load of server.

While the invention herein disclosed has been described by means of specific embodiments, numerous modifications and variations could be made thereto by those skilled in the art without departing from the scope and spirit of the invention set forth in the claims.

What is claimed is:

1. A method for synchronously updating screen data of a database application program at a plurality of clients, the method comprising:
installing a reference table at a server of a network system;
recording filenames of databases in a database system opened by the clients over the network system in the reference table;
when one of the clients updates data of the database at the server, enabling the client to read the reference table for identifying the filenames of the databases opened by the other clients; and
transmitting updated data at one client to the other clients; and
updating data of corresponding fields on a screen of the database application program at each of the other clients.

2. The method of claim 1, wherein the network system comprises at least one server and a plurality of clients coupled to the server, and each client and the server are capable of communicating data by utilizing a network communication protocol implemented on the network application program installed in the network system.

3. The method of claim 2, wherein the network communication protocol is a Transport Control Protocol/Internet Protocol (TCP/IP) communication protocol.

4. The method of claim 1, wherein the database system comprises at least one database for storing a variety of records each having a unique filename of the database.

5. The method of claim 1, wherein the database application program installed in each client is capable of entering the database system, so that the screen of the database application program at each client is available for a user to enter the database system at the server and to input data into the record of the database or search data stored in the records of the database.

6. The method of claim 1, wherein each client is capable of entering the database system at the server by executing the installed database application program and the database application program of the database system downloaded from the server.

7. The method of claim 1, wherein the reference table comprises a plurality of fields for storing an IP address, a communication port number, and the filename of the database opened by the database application program of each client coupled to the server,

8. The method of claim 7, wherein when each client enters the database system at the server for inputting or searching data, the server performs the steps of:
detecting and reading the IP address, the communication port number, and the filenames of the open databases of the database system at each client;
sequentially writing the same into the corresponding fields of the reference table;
determining whether an updating is performed on the record of the database corresponding to the filename of the database being opened after each client has entered the server; and
if a result in the determination is positive, transmitting contents of the reference table to the clients after the updating.

9. The method of claim 8, wherein after the reference table transmitted from the server has been received therein, the client performs the steps of:
reading contents of the fields of the reference table for identifying the filenames of the databases opened by the other clients; and
transmitting updated data to the other clients for updating data of the related fields on the screen of the database application program at each of the other clients.
